(19) United States
(12) Patent Application Publication
(10) Pub. No.: US 2007/0129931 A1
(43) Pub. Date: Jun. 7, 2007

(54) Apparatus and method for supporting prototype development of embedded system

(76) Inventors: Ji Hyun Lee, Daejeon (KR); Jin Hee Cho, Daejeon (KR); Kyung Min Park, Daejeon (KR); Jin Sam Kim, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/633,274

(22) Filed: Dec. 4, 2006

(30) Foreign Application Priority Data
Dec. 5, 2005 (KR) 2005-117697
Jul. 10, 2006 (KR) 2006-64259

(51) Int. Cl. G06F 9/455

(52) U.S. Cl. 703/28

(57) ABSTRACT

An apparatus and method for supporting prototype development of an embedded system are provided. The apparatus includes: a requirements analysis unit analyzing information about requirements and use cases of the embedded system which are input by a user to create a use case analysis table; an architecture design unit analyzing at least one of software and hardware structures of the embedded system which are input by the user and constituents of each of the software and hardware structures to create a structure graph for system, and reflecting the created structure graph for system in the use case analysis table created by the requirements analysis unit to update the use case analysis table; an architecture behavior definition unit defining behavior information including an execution flow and call relationship between the constituents defined by the architecture design unit; an integrated implementation unit creating a code so that the constituents defined by the architecture design unit operate according to the behavior information defined by the architecture behavior definition unit, and implementing the system while checking whether or not a function of each constituent is executed; and a test unit testing function and performance of the implemented system. Thereby, the system development based on the design mixing the hardware and software can divide changes and corrections that can take place during the development process at a high level of a development initial step, so that the system can be constructed from the ground up.

### CROSS-REFERENCE TO RELATED APPLICATION

This application claims priority to and the benefit of Korean Patent Application Nos. 2005-117697, filed Dec. 9, 2005, and 2006-64259, filed Jul. 10, 2006, the disclosures of which are incorporated herein by reference in their entirety.

### BACKGROUND

1. Field of the Invention

The present invention relates to an apparatus and method for supporting prototype development of an embedded system, in which hardware information of a target system is integrated with a software design so that hardware and software can be designed and verified together.

2. Discussion of Related Art

In general, an embedded system refers to a control system equipped with hardware and software that are designed to drive a dedicated computer or a microprocessor to perform special-purpose work or functions. In the embedded system, the software is developed in order to provide differentiated service to meet user requirements that are not supported by hardware. Products equipped with such embedded software have spread to every field of industry: telecommunications, home appliances, health care, aerospace, military, and so on. Embedded software provides various functions and its value is expected to increase further.

The embedded system has a considerably short development cycle compared to other general systems, and a cycle of demand for a new product meeting new user requirements is also short. Conventional design of the embedded system includes a series of processes of deciding hardware specifications, division into hardware and software in the initial stage of development according to the experience of system experts, designing of the hardware and software by different designers, and finally integration of the hardware and software.

In other words, the embedded software has been based on a cross development environment in which it has been developed in a host system and carried out in a target system. However, when developing the embedded system, its hardware and software are not developed at the same time. Specifically, development of the software begins when development of the hardware is completed. Consequently, development of the embedded software has time restrictions and is dependent on development of the hardware.

In such conventional design, because the software is not developed until a prototype of the hardware is completed, a period of time required for design increases. In this case, when hardware design defects are discovered in the process of developing the software, it is considerably difficult to correct the hardware.

Further, incompatibility between the hardware and software is difficult to detect before their integration as such detection requires inspection of functions after integration. Thus, any improper functioning of the integrated system is corrected by modifying the software, which further delays software development.

### SUMMARY OF THE INVENTION

The present invention is directed to providing an apparatus and method for supporting prototype development of an embedded system, in which hardware information of a target system is integrated with a software design so that hardware and software can be designed and verified together.

The present invention is also directed to providing an apparatus and method for supporting prototype development of an embedded system, in which the structure and operation of the system are described at an architecture level, divided into hardware and software realms, and developed and then the hardware and software are integrated to verify operation of the system.

The present invention is also directed to providing an apparatus and method for supporting prototype development of an embedded system, capable of supporting simulation of a prototype of the system by analyzing requirements placed upon embedded software and hardware to design the system.

The present invention is also directed to providing an apparatus and method for supporting prototype development of an embedded system, capable of preventing software and hardware functions from being changed in the future by analyzing system structural requirements prior to system design.

One aspect of the present invention provides an apparatus that supports prototype development of an embedded system. The apparatus comprises: a requirements analysis unit analyzing information about requirements and use cases of the embedded system which are input by a user to create a use case analysis table; an architecture design unit analyzing at least one of software and hardware structures of the embedded system which are input by the user and constituents of each of the software and hardware structures to create a structure graph for system, and reflecting the created structure graph for system in the use case analysis table created by the requirements analysis unit to update the use case analysis table; an architecture behavior definition unit defining behavior information including an execution flow and call relationship between the constituents defined by the architecture design unit; an integrated implementation unit creating a code so that the constituents defined by the architecture design unit operate according to the behavior information defined by the architecture behavior definition unit, and implementing the system while checking whether or not a function of each constituent is executed; and a test unit testing function and performance of the implemented system.

Another aspect of the present invention provides a method for supporting prototype development of an embedded system. The method comprises the steps of: creating a requirement analysis table using information about requirements input by a user; creating a use case analysis table using the created requirement analysis table and use case information input by the user; analyzing at least one of software and hardware structures input by the user and constituents of each of the software and hardware structures to design an architecture structure of each of the software and hardware, and reflecting the designed architecture structure in the created use case analysis table to update the use case analysis table; designing a behavior between the constituents in the designed architecture structure; implementing a code so that the designed architecture structure and behavior are performed in the system as designed; and testing whether or not the designed hardware and software operate normally within a designed execution range.

### BRIEF DESCRIPTION OF THE DRAWINGS

The above and other objects, features and advantages of the present invention will become more apparent to those of ordinary skill in the art by describing in detail preferred embodiments thereof with reference to the attached drawings in which:

FIG. 1 is a schematic block diagram illustrating a configuration of an apparatus for supporting prototype development of an embedded system according to the present invention;

FIG. 2 is a flowchart illustrating a method for supporting prototype development of an embedded system according to the present invention;

FIG. 3 is a flowchart illustrating a method for supporting prototype development of an embedded system performed by a host according to the present invention;

FIGS. 4A through 4K illustrate screen configurations for explaining the method of FIG. 3; and

FIG. 5 illustrates an execution flow of an architecture behavior design according to the present invention.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various types. Therefore, the present embodiment is provided for complete disclosure of the present invention and to fully inform the scope of the present invention to those ordinarily skilled in the art.

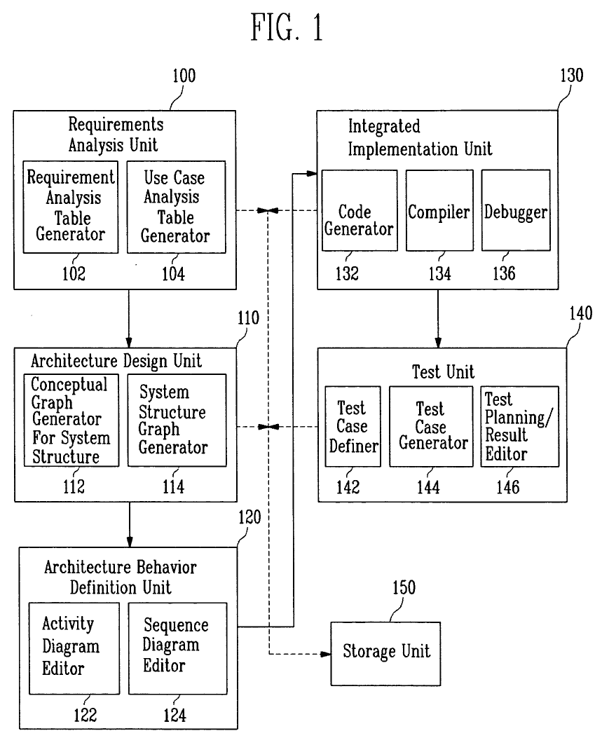

FIG. 1 is a schematic block diagram illustrating a configuration of an apparatus for supporting prototype development of an embedded system according to the present invention.

Referring to FIG. 1, the apparatus for supporting prototype development of an embedded system is comprised of a requirements analysis unit 100, an architecture design unit 110, an architecture behavior definition unit 120, an integrated implementation unit 130, a test unit 140, and a storage unit 150.

The requirements analysis unit 100 receives requirements of services which will be provided by the system and create a requirement analysis table; receives use cases in the format of text and/or diagram to create a use case analysis table.

In other words, when the use cases are input by the user after the requirement analysis table is created, the requirements analysis unit 100 analyzes unit functions and quality attributes required to operate the system using the created requirement analysis table and creates the use case analysis table.

The requirements analysis unit 100 includes a requirement analysis table generator 102 and a use case analysis table generator 104.

When requirements are input by the user, the requirement analysis table generator 102 analyzes the input requirements to create the requirement analysis table listing the requirements. The requirements are input in the form of text.

When the use cases are input by the user, the use case analysis table generator 104 analyzes execution environment, input/output information, attributes, and execution scenario of the input use cases to create the use case analysis table. The use cases are input in the form of text and diagrams.

In other words, the use case analysis table generator 104 isolates unit use cases executed by the system using the analyzed use case scenario and the requirement analysis table created by the requirement analysis table generator 102, and arranges the unit use cases by unit functions, thereby creating the use case analysis table.

The architecture design unit 110 designs structures of software and hardware constituting the system, and defines components of each designed structure, thereby designing the system architecture. That is, the architecture design unit 110 designs a software system structure and a hardware system structure.

The architecture design unit 110 includes a system structure conceptual graph generator 112 and a system structure graph generator 114.

The conceptual graph generator for system structure 112 divides a system structure into software and hardware, and then expresses constituents of the software and constituents of the hardware as conceptual graphs having a hierarchy structure. The constituents of the software and hardware are information input or selected by the user.

For example, in the case of the software, a sub-system, an assembly, a component as a reusable unit constituting the assembly, and an attribute of the component can be defined as a part. Here, the part can take the form of an interface, a function, data, etc., for example.

The hardware constituents include a processor, an interface, an input signal of a target system, electric power, a display device, a serial device, a data format, a register, an instruction, and the like.

The created system structure conceptual graph is a type wherein information of a target platform related to functions is expressed as a meta-structure.

The system structure graph generator 114 analyzes structural characteristics of the system based on constituents expressed as the conceptual graph of system structure created by the conceptual graph generator for system structure 112, thereby creating a structure graph for system. The structure graph for system includes a software structure graph and a hardware structure graph.

Specifically, the system structure graph generator 114 analyzes constituents of the system, a classification indicating whether each of the constituents is to be implemented as hardware or software, related constituents having dependent relationships for interaction, constituents included in high- and low-level structure concepts, interfaces for exchanging data or control information with the related constituents, and so on while gradually going from an upper level to a lower level in a hierarchy expressed on the conceptual graph of system structure, thereby creating the structure graph for system.

Further, the system structure graph generator 114 reflects elements of the structure graph for system in the use case analysis table created by the use case analysis table generator 104, thereby updating attribute information created as a function of the system.

In other words, when information on the structure graph for system is reflected in the use case analysis table, and then information on the system structure is revised according to variation of the use case analysis table, the revised information is reflected back on the structure graph for system.

The architecture behavior definition unit 120 defines a function execution flow and calling relationship between architecture constituents designed by the architecture design unit 110, thereby defining constraints on a quality attribute so as to be designed together with the function execution flow.

The architecture behavior definition unit 120 performing this function is comprised of an activity diagram editor 122 and a sequence diagram editor 124.

The activity diagram editor 122 forms execution logic for executing functions of the system using information about the function of the dependent constituents defined by the structure graph for system. In other words, the activity diagram editor 122 plays a role in forming the execution logic between dependent constituents selected by the user.

Further, the activity diagram editor 122 divides the execution flow expressed as an activity diagram by regions, using a high-level constituent analyzed on the structure graph for system, and verifies whether or not a function to be executed by the high-level constituent is good enough for an interface required when communicating with another constituent.

The sequence diagram editor 124 expresses the execution flow of the activity diagram expressed by the activity diagram editor 122, as a sequence flow.

That is, the sequence diagram editor 124 analyzes the execution logic with a constituent starting operation of the sequence flow, the execution flow, of the activity diagram, a function called by the constituent, and another reachable constituent. Here, the execution logic is defined together with a called function, a type and real value of a transferred function parameter, a time constraint, previous state information of a completed hardware constituent, and information about mapping to a hardware instruction.

The integrated implementation unit 130 develops an implementation code, which can be executed in a host system, using information about the architecture structure design designed at the architecture design unit 110 and information about the behavior design designed at the architecture behavior definition unit 120.

Further, the integrated implementation unit 130 compiles the developed implementation code, determines whether or not a function of the compiled code is performed as designed, and when there is an error, supports finding the cause of the error.

The integrated implementation unit 130 includes a code generator 132, a compiler 134, and a debugger 136.

The code generator 132 creates a code, which can be executed in a host environment, using the architecture structure design information and the behavior design information.

The compiler 134 converts the code created by the code generator 132 into an execution file that can be executed in the host environment.

When an unpredictable function or an erroneous operation occurs at the code converted by the compiler 134, the debugger 136 supports finding its cause.

The test unit 140 functions to create a test program and evaluate whether or not the created test program operates according to a test scenario input by the user. Specifically, when the user defines a test case in order to evaluate whether or not the hardware and software information operate normally within a designed execution range, the test unit 140 creates a test planning for the defined test case, and then creates the test program.

Then, the test unit 140 tests function and performance of the implemented system using the created test program, and documents the results.

The test unit 140 includes a test case definer 142, a test case generator 144, and a test planning/result editor 146.

The test case definer 142 receives the test case from the user in order to evaluate whether or not the hardware and software information operate normally within the designed execution range. The test case includes a test target function call range expressed in the test scenario, a called function of a target module, input data, a prediction result value, and so on.

The test case generator 144 designs an execution flow and a result value to be checked based on the test case input by the test case definer 142. The test case design information is input into the integrated implementation unit 130 and converted into a program that can be executed in the host system, and the program also including developing a stub and a driver required for the test.

The test planning/result editor 146 functions to edit the test scenario analyzed by the test case definer 142 and design test data, thereby preparing a document. Further, the test planning/result editor 146 functions to edit document analysis information of a log file created through the test.

The storage unit 150 stores the requirement analysis table, the conceptual graph of system structure, the structure graph for system, the use case analysis table, the sequence diagram, the implementation code, the test planning, the test case, the test result, and so on. The stored information is re-used when performing repeated review of the same function, and manually changing the structure or behavior information to verify a similar function.

The apparatus for supporting prototype development configured as described above may exist in a host such as a personal computer (PC).

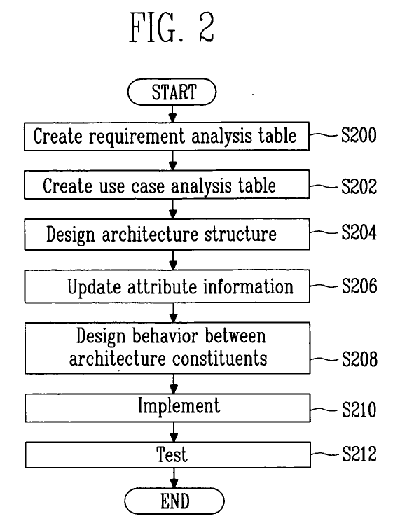

FIG. 2 is a flowchart illustrating a method for supporting prototype development of an embedded system according to the present invention.

Referring to FIG. 2, a host creates a requirement analysis table using information on requirements input by a user (S200). When the user inputs the requirements in the form of text, the host analyzes the input requirements to create the requirement analysis table.

After step S200, the host creates a use case analysis table using information on a use case input by the user (S202).

The user inputs the use case in the form of diagrams and text with respect to a function executed by the system. Then, the host analyzes the input use case to elaborate system configuration environment and function of an upper level.

In the elaborating step, the host divides a use case scenario into constituent unit scenarios, identifies an object taking charge of execution, a quality attribute on the function, and a related use case diagram, and analyzes function and performance elements provided as the function of the system using the use case analysis table.

After step S202, the host designs an architecture structure using information about an architecture structure design input by the user (S204).

In other words, the user divides a structure of the system into hardware and software, and then selects or inputs constituents of the hardware and software. Then, the host creates a conceptual graph of system structure on which each constituent has a hierarchy structure with respect to each of the hardware and software.

The conceptual graph of system structure functions to describe an interface that when performing a mixture design on the embedded system, divides a necessary design target into the hardware and software and combines the two constituents.

In this manner, when the conceptual graph of system structure is created, the host analyzes a structural characteristic of the system according to the constituents indicated on the created conceptual graph of system structure, thereby creating a structure graph for system.

When the structure graph for system is created, the host identifies the constituents deciding the system structure while gradually extending an object element required for operation of the system from an upper level to a lower level according to a hierarchy defined on the conceptual graph of system structure.

It is determined and indicated whether each of the identified constituents is a target to be processed by the hardware or software. A related constituent having dependency on any of the identified constituents is found and expressed together. If the related constituent has dependency, a constituent necessary to link the two constituents is selected from targets explicitly expressed on the conceptual graph of system structure, and then the selected constituent is defined together on the structure graph for system.

After step S204, the host reversely reflects the created structure graph for system on the use case analysis table, thereby updating attribute information to be created as the function of the system (S206).

In other words, when expressed as the added attribute, the function of the use case analysis table is a high level or has enough size to be subdivided, and thus reflection of the attribute information is difficult. In this case, the function is expressed by decomposition into sub-functions. The decomposition of the function provides a method of gradually analyzing a function required for implementation from the high-level function described by the use case scenario. The function of the use case analysis table is decomposed, analyzed, and it is expressed which element the decomposed sub-functions have correlation with on the related structure graph for system.

After step S206, the host designs a behavior between the designed architecture constituents (S208).

Here, the user defines an execution flow in order to exchange an element, and data or control information that are dependent on or related to each of the designed architecture constituents. The execution flow is defined as logic by which a function is called and functions bound according to each system constituent in which the function is included are defined as an interface.

A relationship where the interface and the functions are called according to the dependent constituent defined on the structure graph for system is expressed as a function signature. The function signature is defined together with a return value, a parameter type, time constraints, previous-state information, and a hardware instruction. The interface is expressed as a set of functions having a type of the function signature.

After step S208, the host implements a code so that the designed architecture structure and behavior can be executed in the system as designed (S210).

After step S210, the host creates a test program in order to check whether or not the hardware information and the software information can operate normally within a designed execution range, and then performs a test of the function and performance of the implemented system (S212).

Results after performing the test in step S212 are stored.

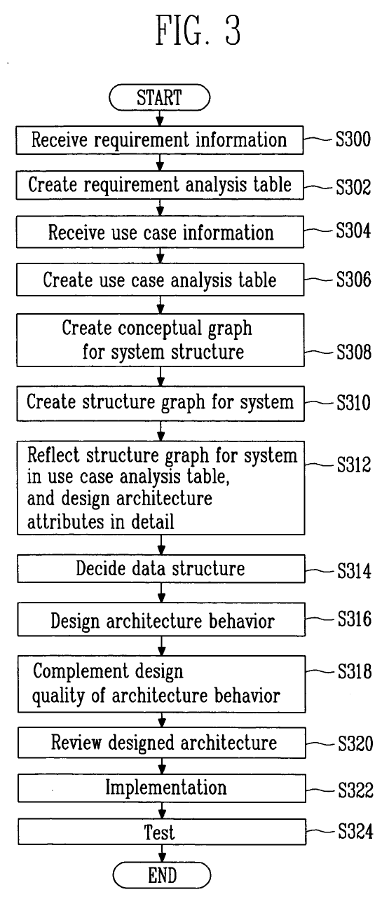

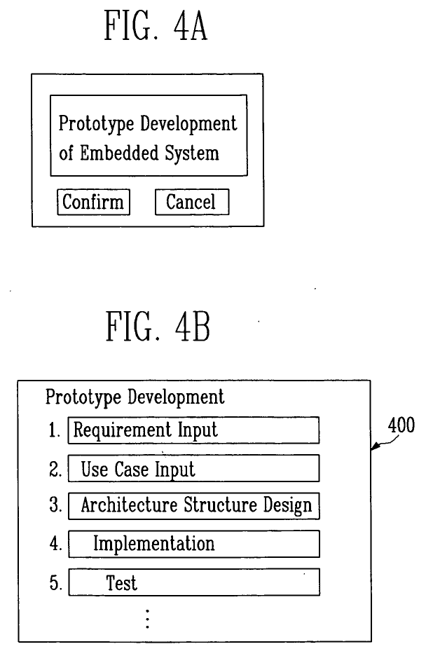

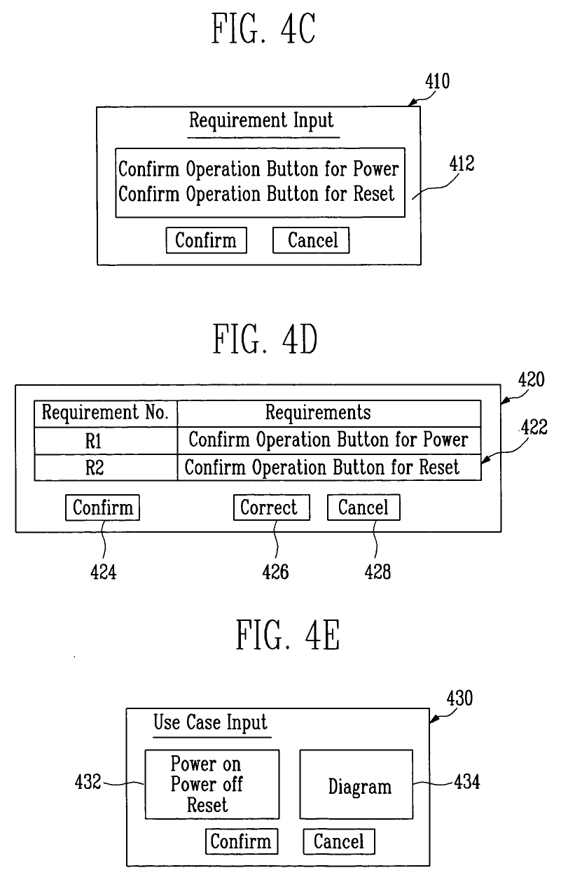

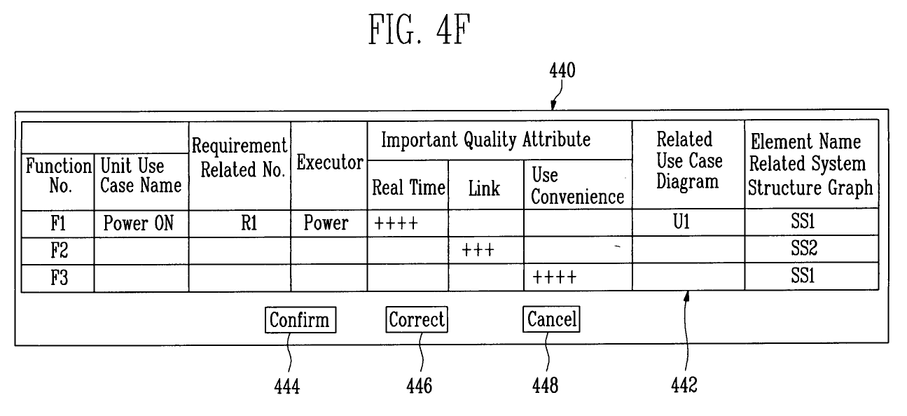

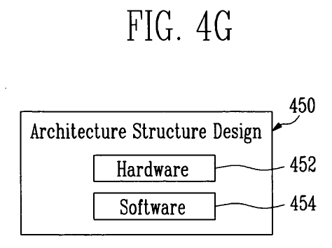

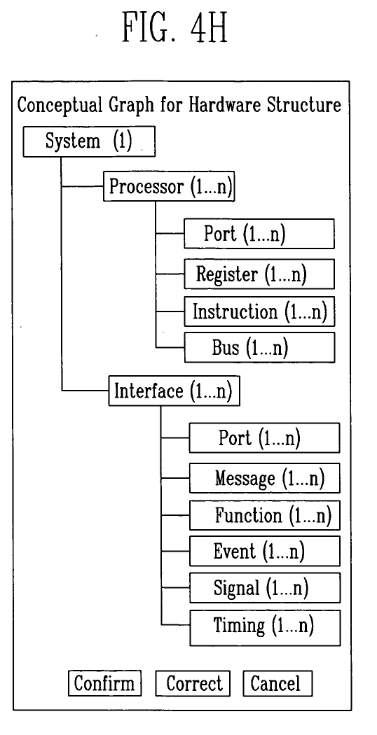

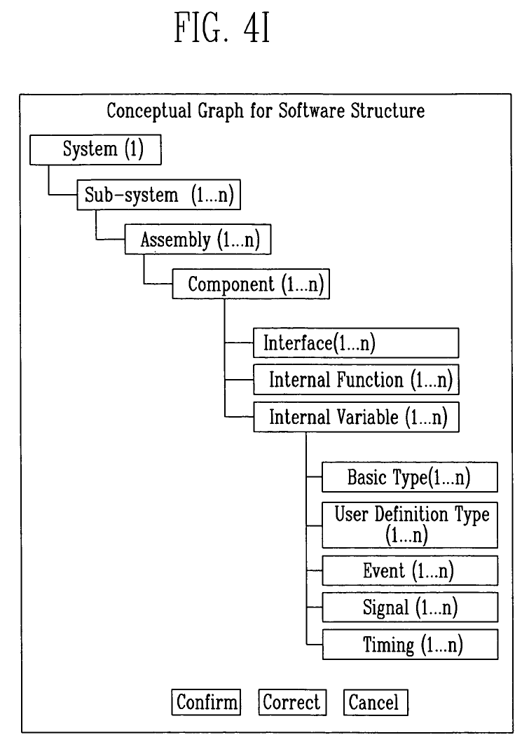

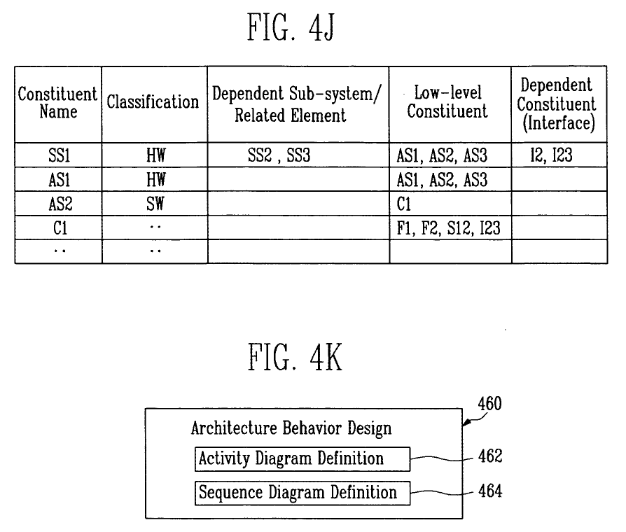

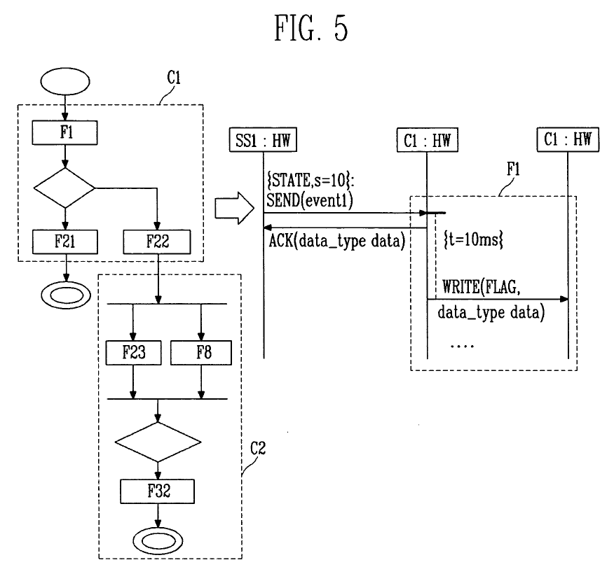

FIG. 3 is a flowchart illustrating a method for supporting prototype development of an embedded system performed by a host according to the present invention. FIGS. 4A through 4K illustrate screen configurations for explaining the method of FIG. 3. FIG. 5 illustrates an execution flow of an architecture behavior design according to the present invention.

Referring to FIG. 3, when information on requirements is input by the user (S300), the host creates a requirement analysis table using the input requirement information (S302). In other words, the user selects a prototype development menu of the embedded system through the host in order to develop a prototype of the embedded system as in FIG. 4A.

Then, the host displays a sub-menu screen for the prototype development as in FIG. 4B. Referring to FIG. 4B, the prototype development sub-menu includes requirement input instructions, use-case input instructions, architecture structure design instructions, implementation instructions, and test instructions.

First, the user selects the requirement input instructions in order to input requirements.

Then, the host displays a requirement input screen as in FIG. 4C. The user inputs desired requirements on a requirement input region 412 of the displayed requirement input screen 410. The input requirements may have the form of text.

When the user completes inputting the requirements, the host creates and displays a requirement analysis table 422 using the input requirements as in FIG. 4D. The requirement analysis table 422 is composed of a description and the number of requirements input by the user. For example, when the user inputs “power button operation confirmation” and “reset button operation confirmation,” the host creates the requirement analysis table 422 in which “power button operation confirmation” and “reset button operation confirmation” are given in a requirement description box.

The user looks at the displayed requirement analysis table 422, and selects a confirmation instruction 424 when the requirements are input as he/she wants. Then, the host stores the created requirement analysis table 422 in the storage unit.

If the user intends to correct the displayed requirement analysis table 422 and thus selects a correction instruction 426, the host displays the requirement input screen 410. Then, the user can correct the requirements using the displayed requirement input screen 410.

Further, if the user selects the correction instruction 426, the host activates a curser in the requirement analysis table 422 so that the requirements can be directly corrected in the displayed requirement analysis table 422. Then, the user can directly correct the requirements using the curser.

As described above, when the requirements are input and thus the requirement analysis table is created, the host receives information about a use case from the user (S304). The user inputs the use case in the form of text and diagrams.

After step S304, the host creates a use case analysis table using the input use-case information and the created requirement analysis table (S306).

In other words, when the user selects a use-case input instruction on the sub-menu screen for the prototype development as in FIG. 4B, the host displays a use-case input screen 430 as in FIG. 4E.

The use-case input screen 430 includes a text input region 432 and a diagram input region 434. The user inputs the use case in the form of text such as “power on,” “power off,” and “reset” in the text input region 432, and then the diagram input region 434 expresses the use case, which is input in the form of text, as a diagram.

Then, the host analyzes execution environment, input/output information, attributes, and execution scenario of the input use case. Afterwards, the host divides unit use cases executed in the system using the analyzed use-case scenario and the requirement analysis table, arranges the divided unit use cases according to function to create the use case analysis table, and displays a use case analysis table screen 440 as in FIG. 4F.

The use case analysis table 442 is composed of a function number, a unit use case name, a requirement related number, an executor, an important quality attribute, a related use case diagram, a related structure graph for system element name, and the like.

Here, the executor is a target taking charge of the function, and its role is decided by constituents of the hardware and software of a higher concept. The important quality attribute analyzes and enumerates elements necessary to meet the requirements of the system of interest, and indicates how much the requirements should be met. The related use case diagram indicates a related diagram among the use case diagrams input by the user. The related structure graph for system element name is to be added in the future when the structure graph for system is formed.

When the displayed use case analysis table 442 is created as desired by the user, the user selects a confirmation instruction 444. Then, the host stores the use case analysis table 442 in the storage unit.

If the user wants to correct the created use case analysis table 442, he/she selects a correction instruction 446. Then, the host moves a curser so that correction can be directly carried out in the use-case input screen 430 as in FIG. 4E or the use case analysis table 442. Then, the user can directly make the correction in the use case analysis table 442.

After step S306, the host creates a conceptual graph of system structure using information about the system constituents input by the user.

In other words, when the user selects an architecture structure design instruction, the host displays an architecture structure design screen 450 as in FIG. 4G. The architecture structure design screen 450 includes a hardware instruction 452 for setting constituents of the hardware of the architecture, and a software instruction 454 for setting constituents of the software of the architecture.

When the user selects the hardware instruction 452, the host displays a hardware constituent selection screen. The hardware constituent selection screen may be a screen on which pre-stored information about the hardware constituents is output as in FIG. 4H or in which an input region of the hardware constituent exists so that the user can directly input the hardware constituents. The user can directly select or input a desired constituent on the displayed hardware constituent selection screen.

Then, the host displays a hardware structure conceptual graph as in FIG. 4H. The hardware structure conceptual graph includes a system, a processor, an interface, processor attribute parts, interface attribute parts, and so on. A hardware simulator may include an input signal of the target system, electric power, a display device, a serial device, a data format, a register, an instruction, and the like.

When the user selects a software instruction 454 on the architecture structure design screen 450, the host displays a software constituent selection screen. The software constituent selection screen may be a screen on which pre-stored information about the software constituent is output as in FIG. 4I or in which an input region of the software constituent exists so that the user can directly input the software constituent. The user can directly select or input a desired constituent on the displayed software constituent selection screen.

Then, the host displays the software structure conceptual graph as in FIG. 4I. The software structure conceptual graph can define as a part a sub-system, an assembly, a component as a reusable unit constituting the assembly, and an attribute of the component.

On the conceptual graph of system structure, a suffixed symbol “(1)” means that the number of elements which each constituent can have is at least one, and a suffixed symbol “(1 . . . n)” means that the number of elements which each constituent can have has a range from at least one to n.

When the conceptual graph of system structure is created through step S308, the host analyzes a structural characteristic of the system according to each constituent indicated on the created conceptual graph of system structure, thereby creating a structure graph for system (S310).

In other words, the host analyzes constituents of the system, a classification indicating whether each of the constituents is to be implemented as hardware or software, related constituents having dependent relationships for interaction, constituents included in high- and low-level structure concepts, and interfaces for exchanging data or control information with the related constituents, thereby creating the structure graph for system as in FIG. 4J.

The structure graph for system includes constituent names, classification, dependent sub-systems/related elements, low-level constituents, dependent constituents, and so on.

Among the symbols represented in FIG. 4J, “SS” refers to a sub-system, “HW” refers to hardware, “SW” refers to software, “AS” refers to an assembly, “C” refers to a component, “I” refers to an interface, and “F” refers to a function.

When step S310 is carried out, the host reflects the created structure graph for system on the use case analysis table, thereby designing architecture attributes in detail (S312).

In other words, when the information analyzed on the structure graph for system is reflected on the use case analysis table, and when information on the system structure is revised according to variation of the use case analysis table, the revised information is reflected back on the analysis information of the structure graph for system. When the structure graph for system is reflected on the use case analysis table, the use case analysis table includes an element name of the related structure graph for system.

When the structure graph for system is reflected on the use case analysis table, functional complement based on the architecture structure is carried out, and the reflected information of the use case analysis table corrects and complements an influence on the architecture constituents.

After step S312, the host defines a function configuring the designed architecture structure, and data and control information to be used as parameters of the interface, thereby deciding a data structure (S314). The defined function, data, and control information are provided as reference information when an implementation code is created in the future.

After step S314, the host expresses a behavior executed in the system with the architecture constituents, the interface and function, as a function execution flow between the constituents, thereby designing an architecture behavior (S316). In other words, when the user selects an architecture behavior design instruction, the host displays an architecture behavior design screen 460 as in FIG. 4K. The architecture behavior design screen 460 includes an activity diagram design instruction 462 and a sequence diagram design instruction 464.

The user selects the activity diagram design instruction 462 to express the behavior executed in the system with the architecture constituents, the interface and function, as the function execution flow between the constituents. Then, the user selects the sequence diagram design instruction 464 to define the function execution flow and call relationship between the architecture constituents selected in the designed activity diagram, thereby designing the architecture behavior in detail.

The execution flow of the architecture behavior design will be described with reference to FIG. 5.

Referring to FIG. 5, an execution flow is expressed as an activity diagram, symbols “F” and “C” refer to the function and component analyzed in the structure graph for system. In the execution flow, “SS1:HW” indicates a sub-system “SS1” classified as hardware, and “C1:HW” indicates a component “C1” classified as hardware.

“{state, s=10}:SEND(event1)” expressed as an attribute of the execution flow means that, when a previously terminated state “s” has a value of “10,” an instruction “send” of a hardware simulator using “event1” as a parameter is called.

“ACK(data_type data)” sent from “C1:HW” to “SS1:HW” indicates that a function of “C1:HW” called to “SS1:HW” is “ACK(data_type data)” as a function signature, and an actually mapped parameter value is “data.”

Therefore, the execution flow shows that a “SEND(event1)” function is called when the state “s” is “10,” and the function “ACK(data_type data)” informing the called state is called. Thereafter, a “WRITE(FLAG, data_type data)” function is called within a time of “10 ms.”

After step S316, the host receives attribute information about design quality of the designed architecture behavior, thereby complementing the design quality of the architecture behavior (S318). In other words, the user expresses information necessary to execute the architecture behavior, such as time constraints, instruction call of the hardware simulator, previous state information confirmation and so on, in execution logic in order to execute the architecture behavior.

When step S318 is performed, the host reviews the designed architecture (S320). That is, the host performs design of the architecture behavior, detailed design of the architecture behavior, and complement of the quality attribute, and then checks whether consistency of the architecture design is maintained, whether the system operates normally, whether operation is performed and then terminated, and whether there are any excluded constituents or processes.

After step S320, the host implements a code to be performed in the system according to the designed structure and behavior (S322).

After step S322, the host tests the implemented code (S324). That is, the host creates a test program for the implemented code and thereby evaluates whether the implemented code operates according to a test scenario.

The evaluation result is stored in the storage unit. The host creates a code integrated into a high-level concept of the architecture design structure using the code implemented in step S322, and creates a test program for the integrated code to evaluate whether the integrated code operates according to a test scenario.

For example, the host tests parts of the components, integrates the components, tests the assembly, and integrates and tests the assembly and the sub-system. Thereafter, the host integrates the system. Then, the tested results are stored in the storage unit.

As described above, the host designs the function of the embedded system by means of a high-level system architecture that takes into consideration both the hardware and the software, and the functions of the hardware and the software based on this design, in detail.

In the detailed design process, integration is carried out based on information about the architecture independently developed and designed in such a manner that a section to be developed as hardware and a section to be developed as software are divided. By sharing such a high-level design, it is possible to develop a design-based prototype system that can be performed according to requirements in the host environment.

The method of the present invention as described above can take the form of a computer program stored on a computer-readable recording medium. A skilled programmer can readily write the method as a computer program, and thus this will not be described in detail.

As described above, in an apparatus and method for supporting prototype development of an embedded system according to the present invention, hardware and software of a target system are designed simultaneously, so that the structure and function of the system can be verified.

Further, due to the system development based on the design mixing the hardware and software, changes and corrections that can take place during the development process are divided at a high level of an initial development step, so that the system can be constructed from the ground up.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An apparatus for supporting prototype development of an embedded system, the apparatus comprising:
a requirements analysis unit analyzing information about requirements and use cases of the embedded system which are input by a user to create a use case analysis table;
an architecture design unit analyzing at least one of software and hardware structures of the embedded system which are input by the user and constituents of each of the software and hardware structures to create a structure graph for system, and reflecting the created structure graph for system in the use case analysis table created by the requirements analysis unit to update the use case analysis table;
an architecture behavior definition unit defining behavior information including an execution flow and call relationship between the constituents defined by the architecture design unit;
an integrated implementation unit creating a code so that the constituents defined by the architecture design unit operate according to the behavior information defined by the architecture behavior definition unit, and implementing the system while checking whether or not a function of each constituent is executed; and
a test unit testing function and performance of the implemented system.

2. The apparatus according to claim 1, further comprising a storage unit storing reusable information among the pieces of information created by the requirements analysis unit, the architecture design unit, the integrated implementation unit, and the test unit.

3. The apparatus according to claim 1, wherein the requirements analysis unit comprises:
a requirement analysis table generator analyzing the requirement information of the embedded system which is input by the user to create a requirement analysis table; and
a use case analysis table generator analyzing the use case information input by the user and the requirement analysis table created by the requirement analysis table generator to create the use case analysis table.

4. The apparatus according to claim 3, wherein the requirement analysis table comprises the requirement information and requirement identification number input by the user.

5. The apparatus according to claim 1, wherein the use case analysis table comprises at least one of a function number, a unit use case name, a requirement related number, an executor, an important quality attribute, a related use case diagram, and a related structure graph for system element name.

6. The apparatus according to claim 1, wherein the architecture design unit comprises:
a conceptual graph generator for system structure analyzing each constituent of at least one of the software and hardware of the system input by the user to create a conceptual graph of system structure having a hierarchy structure; and
a system structure graph generator analyzing structural characteristics of the system based on constituents indicated on the conceptual graph of system structure created by the conceptual graph generator for system structure to create a structure graph for system, and reflecting the created structure graph for system in the use case analysis table created by the requirements analysis unit to update the use case analysis table.

7. The apparatus according to claim 1, wherein the structure graph for system comprises constituents of the system, a classification indicating whether each of the constituents is to be implemented as hardware or software, related constituents having dependent relationships for interaction, constituents included in high- and low-level structure concepts, and interfaces for exchanging data or control information with the related constituents.

8. The apparatus according to claim 1, wherein the architecture behavior definition unit comprises:
an activity diagram editor defining an execution flow for executing functions of the system using information about a function of the dependent constituents defined on the structure graph for system created by the structure graph for system generator; and
a sequence diagram editor defining execution logic for a constituent starting operation of the execution flow defined by the activity diagram editor, a function called by the constituent, and another reachable constituent.

9. The apparatus according to claim 1, wherein the integrated implementation unit comprises:
a code generator creating a code so that the constituent defined by the architecture design unit operates according to the behavior information defined by the architecture behavior definition unit;
a compiler converting the code created by the code generator into an execution file that can be executed in a host environment; and
a debugger performing debugging on the code converted by the compiler.

10. The apparatus according to claim 1, wherein the test unit comprises:
a test case definer receiving a test case from the user in order to evaluate whether or not the hardware and software information constituting the system operate normally within a designed execution range;
a test case generator designing the execution flow and a result value to be checked based on the test case input by the test case definer; and
a test planning/result editor editing the test case analyzed by the test case definer to design test data, and converting analysis information of a log file created by a test into a document.

11. A method for supporting prototype development of an embedded system, the method comprising the steps of:
creating a requirement analysis table using information about requirements input by a user;
creating a use case analysis table using the created requirement analysis table and use case information input by the user;
analyzing at least one of software and hardware structures input by the user and constituents of each of the software and hardware structures to design an architecture structure of each of the software and hardware, and reflecting the designed architecture structure in the created use case analysis table to update the use case analysis table;
designing a behavior between the constituents in the designed architecture structure;
implementing a code so that the designed architecture structure and behavior are performed in the system as designed; and
testing whether or not the designed hardware and software operate normally within a designed execution range.

12. The method according to claim 11, wherein the requirement information is input in the form of text.

13. The method according to claim 11, wherein the requirement analysis table comprises the requirement information input by the user and a requirement number.

14. The method according to claim 11, wherein the use case information is input in the form of at least one of text and a diagram.

15. The method according to claim 11, wherein the use case analysis table comprises at least one of a function number, a unit use case name, a requirement related number, an executor, a important quality attribute, a related use case diagram, and a related structure graph for system element name.

16. The method according to claim 11, wherein the step of analyzing at least one of software and hardware structures input by the user and the constituents of each of the software and hardware structures to design an architecture structure of each of the software and hardware, and reflecting the designed architecture structure in the created use case analysis table to update the use case analysis table, comprises the steps of:
creating a conceptual graph of system structure using at least one of the software and hardware structures input by the user and the constituents of each of the software and hardware structures;
analyzing structural characteristics of the system according to the constituents indicated on the created conceptual graph of system structure to create a structure graph for system; and
reflecting the created structure graph for system in the use case analysis table to update the use case analysis table.

17. The method according to claim 16, wherein the conceptual graph of system structure is a meta-structure.

18. The method according to claim 16, wherein the conceptual graph of system structure comprises a conceptual graph for hardware structure and a conceptual graph for software structure.

19. The method according to claim 16, wherein the structure graph for system comprises at least one of constituents of the system, a classification indicating whether each of the constituents is to be implemented as hardware or software, related constituents having dependent relationships for interaction, constituents included in high- and low-level structure concepts, and interfaces for exchanging data or control information with the related constituents.

20. The method according to claim 11, wherein the step of designing a behavior between the constituents in the designed architecture structure, comprises the steps of:
defining execution logic for performing a function of the system using information about a function of dependent constituents defined on the structure graph for system; and
designing execution logic for the constituent starting operation of the defined execution logic, a function called by the constituent, and another reachable constituent.

21. The method according to claim 20, wherein the execution logic is defined together with a called function, a type and real value of a transferred function parameter, a time constraint, previous state information of a completed hardware constituent, and mapping information to a hardware instruction.

22. The method according to claim 11, wherein the step of implementing a code so that the designed architecture structure and behavior are performed in the system as designed, comprises the steps of:
compiling and analyzing the implemented code; and
determining whether or not the designed architecture structure and behavior perform a function as designed, and when there is a defect, finding a cause of the defect.

23. The method according to claim 11, wherein the step of testing whether or not the designed hardware and software operate normally within a designed execution range, comprises the steps of:
defining a test case for evaluating whether or not the designed hardware and software operate normally within the designed execution range;
converting the test case into a test program using a call range of test target function expressed in the test case, a called function of a target module, input data, and a prediction result value; and.
outputting analysis information of a log file created by a test of the converted test program as a test result.
